(19) United States
(12) Patent Application Publication
(10) Pub. No.: US 2012/0224212 A1
(43) Pub. Date: Sep. 6, 2012

(54) METHOD AND DEVICE FOR ISSUING TICKETS

(76) Inventors: Zhigang Xu, Weihai (CN); Chuntao Wang, Weihai (CN); Lei Che, Weihai (CN); Guangdong Hu, Weihai (CN); Xin Wang, Weihai (CN)

(21) Appl. No.: 13/508,354

(22) PCT Filed: Nov. 4, 2010
(86) PCT No.: PCT/CN10/78432

§ 371 Date: May 4, 2012

(30) Foreign Application Priority Data
Nov. 6, 2009 (CN) 200910211193.4

(51) Int. Cl. G06K 15/02

(52) U.S. Cl. 358/1.13

(57) ABSTRACT

The present invention discloses a ticket issuing method, comprising: step a: acquiring the image of a ticket paper for issuing a ticket, recognizing a ticket number from the image acquired and determining the validity of the ticket number recognized, to obtain a valid ticket number; step b: printing on the corresponding ticket paper the ticket issuing information containing the ticket number, when receiving a ticket issuing instruction. The present invention also discloses a ticket issuing device, comprising: an image acquisition unit (35), a printing unit (34) and a controller (31) for sending the image of the ticket paper acquired by the image acquisition unit or the ticket number recognized from the image of the ticket paper to a host computer (40) and controlling the printing unit (34) to print on the ticket paper according to the ticket issuing instruction and the ticket issuing information received. The ticket issuing method and the ticket issuing device omit the trouble of the manual input of the ticket number and improve the accuracy of the input of the ticket number. The ticket issuing method and the ticket issuing device can be applied to blank tickets under various numbering rules according to different policies for recognizing ticket numbers, and the disadvantage that the ticket numbers have to be consecutive numbers during the existing ticket issuing process is overcome.

The application claims the priority of Chinese patent for invention with application No. 200910211193.4, titled as “Method and Device for Issuing Tickets” and submitted in Nov. 6, 2009, and all disclosed contents thereof should be incorporated herein by reference.

### TECHNICAL FIELD OF THE INVENTION

The present invention relates to the field of issuing tickets, in particular to a method and a device for issuing tickets.

### BACKGROUND OF THE INVENTION

For the current securities, such as train tickets and bus tickets, to be convenient for unified management, a unique ticket number is printed on each ticket, just like a unique serial number for a tax invoice, and shown at an obvious position on the ticket in plain code.

Staffs in the field can obtain basic information directly from the ticket number and determine the validity of a ticket preliminarily. During the ticket issuing process of tickets to be purchased, the upper system needs to process more detailed information related to the ticket after obtaining the information of the ticket number, for example, the place where the ticket is issued, the machine for making the ticket, the time when making the ticket, and personnel who making the ticket and the like, combines such information together with the ticket number, and shows the combined information on the ticket in the form of cipher text, which for example may be saved on the ticket surface in the form of printing graphic, bar code, or magnetic write data and the like. Therefore, during ticket checking, information deciphered from the cipher text can be compared with the plain text information of the ticket number for further anti-counterfeiting, for example, through the matching of the cipher text information and the plain text information, and the like.

However, during the practical ticket issuing process, it is often difficult to acquire the information of the ticket number in real time. At present, the ticket number is manually input by manually checking the ticket number, so the working efficiency is low, the possibility of making error is high, and also it is difficult to find an error after it occurs.

Therefore, it is urgent to provide a new method and device for issuing ticket overcome the shortage of the manual input of the ticket number.

### SUMMARY OF THE INVENTION

The purpose of the present invention is to provide a ticket issuing method, to realize the automatic identification of the ticket number and decrease the failure rate of the input of the ticket number. The purpose of the present invention is also to provide a ticket issuing device.

Therefore, according to one aspect, the present invention provides a ticket issuing method, comprising: Step a: acquiring the image of a ticket paper for the issuing a ticket, recognizing a ticket number from the acquired image and determining the validity of the recognized ticket number to obtain a valid ticket number; and Step b: printing on the corresponding ticket paper the ticket issuing information containing the ticket number, when receiving a ticket issuing instruction.

Preferably, after Step a is completed, the valid ticket number recognized in Step a is stored, and correspondingly, in Step b, the stored valid ticket number is printed on the corresponding ticket paper as one part of the ticket issuing information.

Preferably, Step b is executed previously to or simultaneously with Step a, the valid ticket number obtained in Step a is one part of the ticket issuing information used for the next ticket issuing instruction, and the ticket issuing information used in Step b contains the valid ticket number which has been already stored and is used for the current ticket issuing instruction.

Preferably, when the ticket issuing device issues a first ticket paper after the ticket issuing device is powered on or a roll of paper is replaced, Step a is executed first and then Step b is executed.

Preferably, in the case of continuous ticket paper for ticket issuing, after Step a is completed, the continuous ticket paper is conveyed to a paper cutting position, and an individual ticket paper is cut off from the continuous ticket paper.

Preferably, in Step a, the validity of a ticket number is recognized by an interval policy or sequence policy of ticket numbers.

Preferably, in Step b, when the ticket paper is a magnetic ticket paper, the ticket issuing information is also written into the magnetic area of the magnetic ticket paper.

According to another aspect, the present invention provides a ticket issuing device, comprising: an image acquisition unit, configured to acquire the image of ticket paper for issuing a ticket; a printing unit, configured to print the ticket issuing information on the ticket paper; and a controller, configured to send the image of the ticket paper acquired by the image acquisition unit or the ticket number recognized from the image of the ticket paper to a host computer and control the printing unit to print on the ticket paper according to the ticket issuing instruction and the received ticket issuing information.

Preferably, the ticket issuing device in the present invention further comprises: a memory, configured to store the ticket issuing information sent by the host computer according to the ticket number, correspondingly, the controller receives the ticket issuing information from the memory.

Preferably, the ticket issuing device in the present invention further comprises: a magnetic write unit, configured to write the ticket issuing information into the magnetic area of the ticket paper, wherein the controller further controls the magnetic write operation of the magnetic write unit according to the ticket issuing instruction.

Preferably, the image acquisition unit, the magnetic write unit and the printing unit are arranged on a ticket paper processing passage of the ticket issuing device in sequence, wherein a ticket cutting mechanism is also arranged on the ticket paper processing passage between the image acquisition unit and the magnetic write unit, for cutting off an individual ticket paper from the continuous ticket paper.

During the ticket issuing process, the control method of automatically scanning the ticket paper, automatically recognizing the ticket number from the scanned image, and printing and magnetically writing the ticket issuing information including the recognized ticket number not only omits the trouble of the manual input of the ticket number, but also greatly improves the accuracy of the input of the ticket number and the working efficiency of the ticket production. The ticket issuing method and the ticket issuing device can be applied to blank tickets paper under various numbering rules according to different policies for recognizing ticket numbers, and overcome the disadvantage that the ticket numbers have to be consecutive numbers during the current ticket issuing process.

According to the ticket issuing device and the ticket issuing method of the present invention, it is unnecessary to improve equipments in printing factories. Of course, printing factories may also add the equipment of pre-writing magnetic information that can be automatically recognized by the current ticket issuing machines, however, the improvement cost of equipment is high, flows such as validation of the consistency between the pre-written magnetic information and the printed ticket number need to be added, and the ticket printing flow and the ticket issuing flow need to be improved simultaneously. Therefore the application is not flexible. According to the ticket issuing device and the ticket issuing method in the present invention, the flexibility of the application is improved.

Besides purposes, features and advantages described above, the present invention also has other purposes, features and advantages.

### BRIEF DESCRIPTION OF THE DRAWINGS

Drawings, which form a part of the description and are provided for further understanding of the present invention, show the preferred embodiments of the present invention, and explain the principle of the present invention together with the description. In the drawings:

FIG. 1 shows a circuit block diagram of a ticket issuing device according to an embodiment of the present invention;

FIG. 2 shows a structural diagram of a ticket issuing device according to a typical embodiment of the present invention;

FIG. 3 shows a logical diagram of data processing when the Optical Character Recognition (OCR) function is built-in the ticket issuing device according to the present invention;

FIG. 4 shows a logical diagram of data processing when the OCR function is performed by a host computer according to the ticket issuing device in the present invention;

FIG. 5 shows a ticket issuing flow chart according to a ticket issuing method in the present invention;

FIG. 6 shows a processing flow chart of an OCR of ticket number according to the ticket issuing method in the present invention;

FIG. 7 shows a manual processing flow diagram of an abnormal ticket number according to the ticket issuing method in the present invention;

FIG. 8 shows a ticket number check processing flow chart according to the ticket issuing method in the present invention; and

FIG. 9 shows a ticket number processing diagram in the present invention.

### DETAILED DESCRIPTION OF THE EMBODIMENTS

The embodiments of the present invention will be described in detail below with reference to drawings, however, the present invention may be implemented by various different ways defined and covered by the claims.

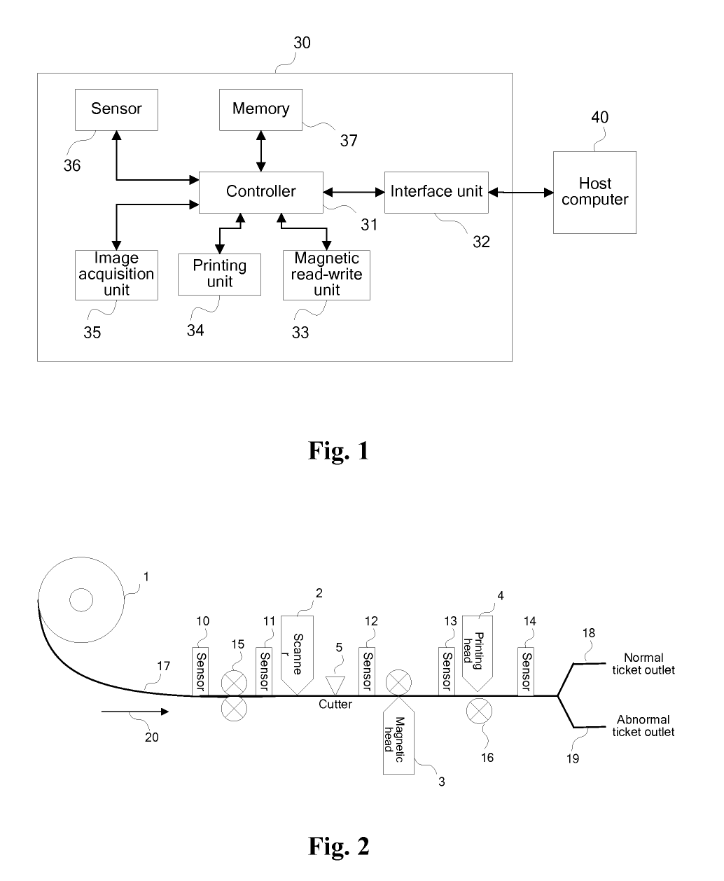

FIG. 1 shows a diagram of a ticket issuing device of an embodiment of the present invention. Description will be given below in accordance with the drawing.

As shown in FIG. 1, the ticket issuing device comprises: a controller 31, an interface unit 32, a magnetic read-write unit 33, a printing unit 34, an image acquisition unit 35 and a sensor 36 and the like.

In the above, the controller 31 controls the data interaction with the host computer, for example, receiving the ticket paper printing command and sending the state of the device and the like, and controlling when to scan the image, when to read/write the magnetic data, and when to print and the like during the ticket issuing process.

The interface unit 32 provides a channel for the data communication between the ticket issuing device and the host computer.

The magnetic read-write unit 33 writes the magnetic data into the magnetic area of the ticket paper and reads out the written magnetic data to check the validity in order to determine the accuracy of the magnetic data.

The printing unit 34 prints data to be printed according to requirements of the control unit. The printing unit may be thermal transfer printing and also may be ribbon printing or inkjet printing and the like.

The image acquisition unit 35 scans the ticket paper according to requirements of the controller 31 and acquires the image data of the ticket paper. The image acquisition unit may be a Contact Image Sensor (CIS) scanning device and may also be a Charge Coupled Device (CCD) device or scanning devices of other types. The acquired image may be a gray image and may also be a color image, and different scanning types are used according to the optical property of the image on the ticket paper.

The sensor 36 detects the position of the ticket paper in the ticket issuing device, for example, the ticket paper is at the position of the scanning unit, at the magnetic read-write unit and at the printing unit and the like, and operation is performed only when the ticket paper reaches the set position of each unit.

The memory 37 stores data sent from the host computer, for example, the magnetic write data of the magnetic read-write unit and the data to be printed by the printing unit, and also stores the scanned data of the scanning unit and the ticket number reference data related to the ticket number and the like, and also stores the detecting data of the sensor 36 and the like. Various operations are performed by the controller 31 according to a certain operation flow: scanning of image, reading-writing of magnetic data, and printing of printing information and the like.

From the constitutional diagram of the ticket issuing device in FIG. 1, the implementation functions of individual constitutional units and the working relationship among the constitutional units can be directly obtained. The actual position relationship among the constitutional units and roles of the constitutional units during the whole ticket issuing process may be understood more clearly through FIG. 2.

As shown in FIG. 2, a scanner 2, a cutter (or called cutter mechanism) 5, a magnetic head 3 and a printing head 4 are distributed on the ticket paper processing passage of the ticket issuing device in sequence. A blank ticket paper roll 1 is placed at the entrance of the channel, and a normal ticket outlet 18 and an abnormal ticket outlet 19 are arranged at the exit of the channel. A plurality of sensors is distributed inside the passage and used for detecting the position of the ticket paper in the passage during the ticket issuing process.

The scanner 2, the sensor 10 and the sensor 11 jointly complete the positioning of the blank ticket paper and the acquisition of the image information of the ticket paper together, wherein the sensor 10 detects whether there is any ticket paper at the ticket inlet, the sensor 11 detects whether the ticket paper is transferred to the scanner 2, and the scanner 2 scans the ticket paper and acquires the scanned image. The scanner may be a CIS device and also may be a CCD device or scanning devices in other types. The cutter 5 performs the ticket paper cutting operation and an individual ticket paper is cut off from the continuous ticket paper. The magnetic head 3 completes the magnetic write operation for the ticket paper and writes the magnetic data into the magnetic area of the ticket paper, and the sensor 12 positions the ticket paper when the magnetic write operation is performed. The magnetic data includes the combined information of the ticket number of the ticket paper recognized from the image acquired by the scanner 2 and other information, such as equipment number, operator number and operation time, which is ciphered and written in the magnetic area of the ticket paper in cipher text. For equipment with higher requirements, a magnetic head for reading magnetic information may be added to read the written magnetic information to check the validity in order to guarantee the accuracy of the written information. The printing head 4 prints the printing information, and the sensor 13 positions the ticket paper when the printing operation is performed. Printing heads of different operation types, for example, thermal transfer printing head and inkjet printing head and the like, may be selected according to the demands of application. The normal ticket is sent out from the normal ticket outlet 18 and the abnormal ticket is sent out from the abnormal ticket outlet 19.

Configuration or process of the device will determine whether the each parts of the device works or not and the work sequence between each single parts. For example, when non-continuous ticket paper is used, the cutter 5 is not required to be actuated; and when the ticket number recognition is not needed, the scanner 5 is not required to scan, and the like.

Above contents describe the ticket issuing device when ticket production is performed by using magnetic ticket paper. When ticket production is performed by using ticket paper not including a magnetic area, the constitutional parts in the ticket issuing device related to the magnetic operation may be omitted. For example, the magnetic read-write unit 33 as shown in FIG. 1, and the magnetic head 3 and the sensor 12 as shown in FIG. 2 are omitted correspondingly.

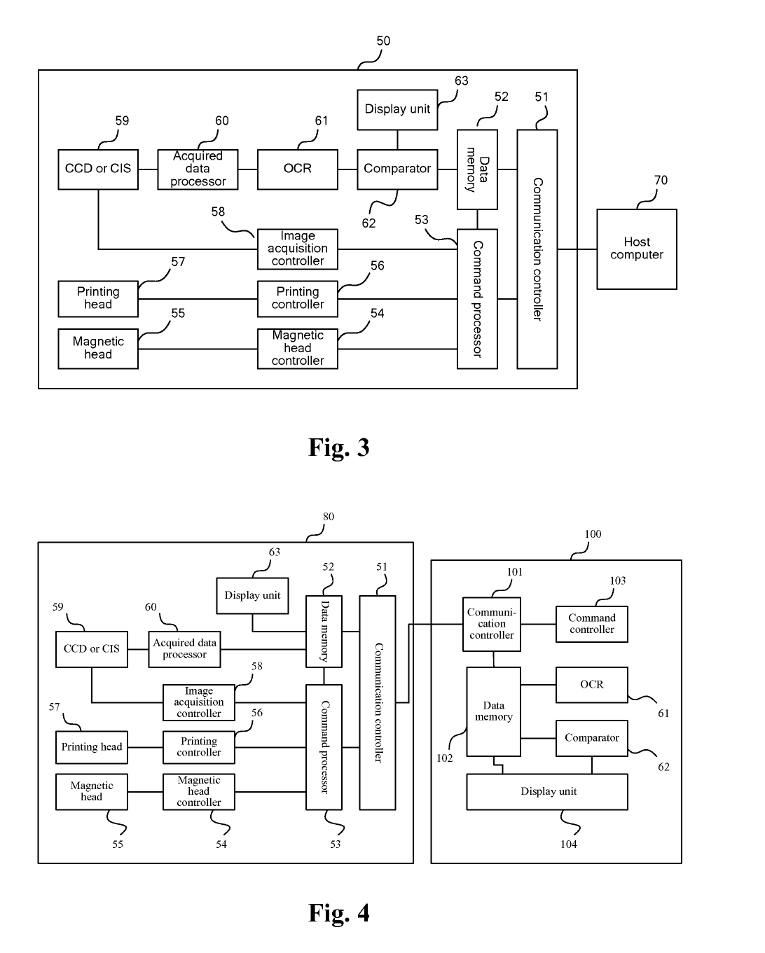

Functions of individual parts in the device may be understood with reference to the function diagram of the ticket issuing system in FIG. 3 and FIG. 4, which show the data processing flow of each part in the device.

FIG. 3 shows a logical diagram of data processing when the OCR function is built-in the ticket issuing device in the present invention. The functions of each logic unit and the process of processing data will be described below according to the drawing.

The ticket issuing system comprises a ticket issuing device 50 and a host computer 70 connected with the ticket issuing device.

The ticket issuing device completes the ticket issuing operation and the ticket number recognition operation of the next ticket paper and the like after receiving a ticket issuing command sent by the host computer, and transfers the result of recognition to the host computer to get ready for the production of the next ticket. And the ticket issuing command sent by the host computer includes the ticket number and other additional information.

The ticket issuing device 50 mainly comprises the following logic function units:

A communication controller 51 is configured to perform communication between the ticket issuing device and the host computer, including receiving various commands sent by the host computer, and sending to the host computer the result of the ticket number recognition of the ticket paper of the ticket issuing device, the progress of the ticket issuing operation and the state of each unit of the ticket issuing device;

A data memory 52 is configured to store various data of the ticket issuing device, for example, various instructions received from the host computer, the processing results of various instructions, and the state data of each unit and the like.

A command processor 53 is configured to analyze the received various commands to determine the operation to be performed, for example, image acquisition, magnetic write operation of the magnetic data, and the printing operation and the like.

An image acquisition controller 58 is configured to control the image acquisition device, for example, CIS scanning device or CCD scanning device and the like, to acquire the image of the ticket paper.

An image acquisition device 59, such as CIS scanning device or CCD scanning device, is configured to acquire the image according to requirements of the image acquisition controller 58, and store the acquired image in the data memory 52.

An acquired data processor 60 is configured to perform a certain optical processing on the image data acquired by the image acquisition device, and correct and compensate the acquired data according to features of scanning devices in different types, so that the acquired data is closer to the real image of the scanned ticket paper and is more convenient for image recognition.

An OCR unit 61 is configured to perform OCR on the acquired image processed by the acquired-data processor to obtain the recognized ticket number of the ticket paper.

A comparator 62 is configured to compare the recognized ticket number of the ticket paper with the valid ticket number. If the recognized ticket number is a valid ticket number, the comparator 62 sends no alarm. If the recognized ticket number is not a valid ticket number, the comparator 62 sends alarm information to a display unit 63 and transfers the result of recognization to the host computer no matter what the result of recognization is.

A magnetic head controller 54 is configured to control the magnetic head 55 to perform magnetic write operation according to requirements of the ticket issuing instruction.

A printing controller 56 is configured to control the printing head 57 to print the printing data on the ticket paper according to requirements of the ticket issuing instruction.

The function units of the ticket issuing device cooperate with each other to jointly complete various operations of ticket production, wherein the image acquisition controller 58 and the image acquisition device 59 jointly complete the image acquisition of the ticket paper; the acquired-data processor 60, the OCR unit 61 and the comparator 62 jointly complete the processing of the acquired image data of the ticket paper and realize the recognition and the validation of the ticket number of the ticket paper and the like. The OCR of the ticket number and the valid determination of the recognized ticket number may be completed by the host computer, and in this way the operation flow of the ticket issuing device is simplified.

The logic functions of the ticket issuing system when the OCR and the valid determination of the recognized ticket number are realized in the host computer will be described below by taking FIG. 4 as example.

The main difference between realization of the OCR and the valid determination of the recognized ticket number in the host computer and realization of the OCR and the valid determination of the recognized ticket number in the ticket issuing device is that, after the acquired-data processor 60 in FIG. 4 performs necessary processing on the image acquired by the image scanning device CIS/CCD, the processed data is directly transferred to the host computer 100, the OCR function unit 61 in the host computer performs OCR for the ticket number, the validity of the recognized ticket number is checked by the comparator 62, and the result of determination is saved in the data memory 102 for use in the next ticket issuing operation.

If the ticket number is not a valid ticket number, the display unit 104 in the host computer 100 and/or the display unit 63 in the ticket issuing device 80 send/sends an alarm indicating. The implementation of OCR of the ticket number and the determination of the validity of the recognized ticket number in the host computer increase the transmission time of the acquired data, but simplifies the complexity of software of the ticket issuing device, and they may be designed or configured according to demands of actual application situations.

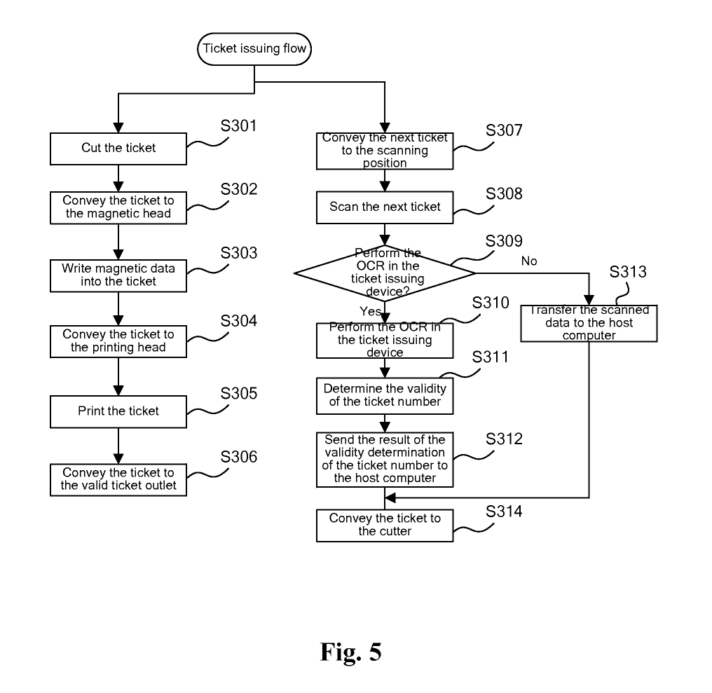

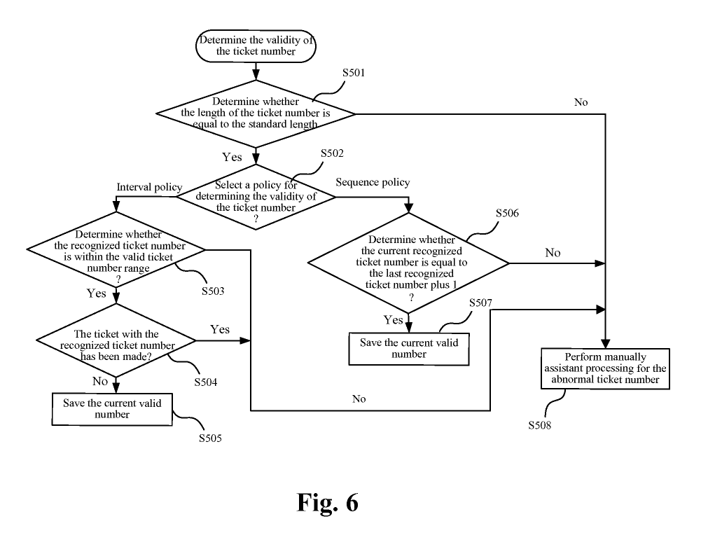

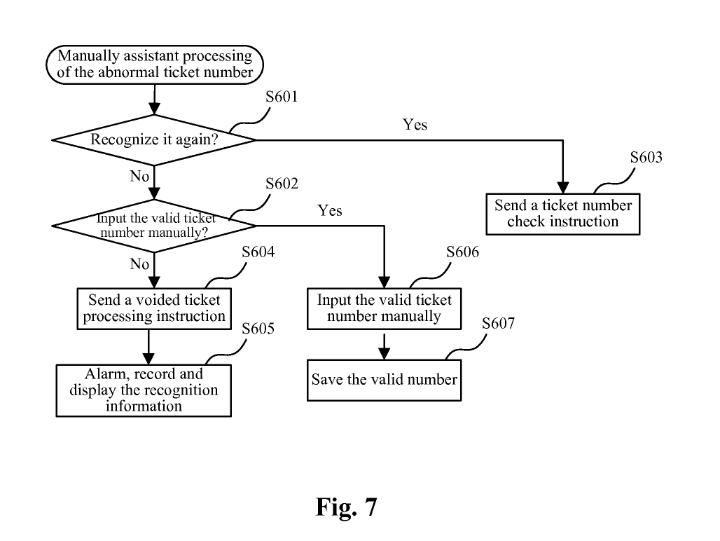

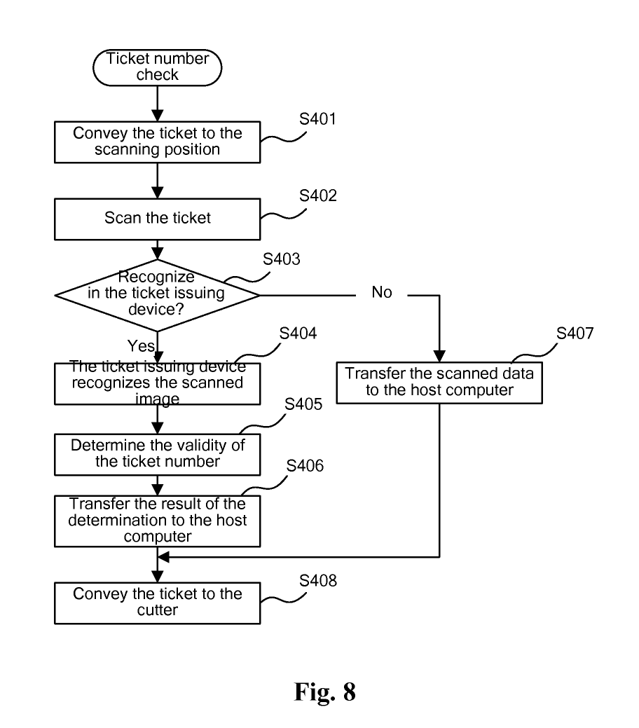

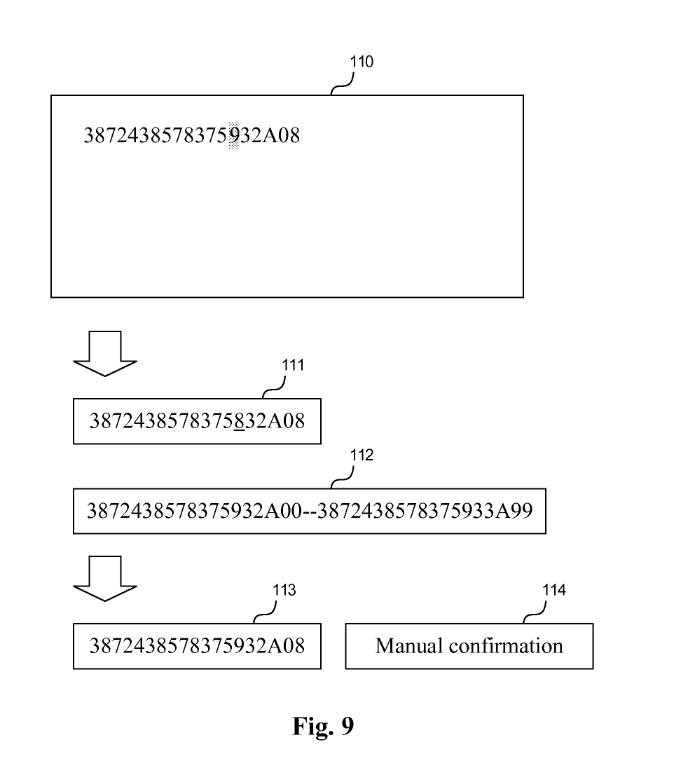

The detailed ticket issuing method and the specific processing flow may be further known and understood through the detailed description in FIG. 5, FIG. 6, FIG. 7, FIG. 8 and FIG. 9.

The ticket issuing method in the present invention comprises: Step a: acquiring the image of a ticket paper for issuing the ticket, recognizing the ticket number from the image acquired and determining the validity of the recognized ticket number; and Step b: when receiving a ticket issuing instruction, printing the ticket issuing information containing the ticket number on the corresponding ticket paper. Usually, Step a is performed first to recognize the ticket number required in issuing the ticket for this time, and then Step b is performed to print the ticket issuing information containing the valid ticket number on the corresponding ticket paper.

Preferably, Step b is performed previously to or simultaneously with Step a, the valid ticket number acquired in Step a is one part of the ticket issuing information used for the next ticket issuing instruction, and the ticket issuing information used in the Step b contains the valid ticket number which has been already stored and used for the current ticket issuing instruction. In this way, while the current ticket is issued, the ticket number of the next ticket paper is recognized to get ready to be used for issuing the next ticket. This avoids the problem that the ticket issuing period is prolonged as it is necessary to wait for the recognition of the ticket number when the sub-flow 2 is performed first and then the sub-flow 1 is performed, thus the ticket issuing speed is improved.

It should be noted that, when the ticket issuing device is powered on or the first segment of ticket paper after a roll of paper is replaced is used for issuing ticket, it is necessary to perform Step a first and perform Step b secondly.

FIG. 5 shows a flow chart of a ticket issuing process in the present invention. As shown in the drawing, the ticket issuing flow comprises a sub-flow 1 and a sub-flow 2, wherein the sub-flow 1 comprises operations, such as writing/reading the magnetic data on the present ticket paper and printing the ticket paper; the sub-flow 2 comprises the image acquisition of the ticket paper and the OCR of the ticket number and the like. In the embodiment, the sub-flow 1 and the sub-flow 2 are performed in parallel.

The sub-flow 1 comprises the following detailed steps:

S301: The ticket paper is cut, wherein an individual ticket paper is cut off from the continuous ticket paper, to be convenient for further processing. The cutting operation is needed only when a roll of continuous ticket paper is used. If an individual ticket paper is used in the ticket issuing device, the cutting operation is not required, so this step may be omitted.

S302: The ticket paper is conveyed to the magnetic head to get ready to write the magnetic data. During this process, a positioning operation may be required, which is assisted by sensors, the description of which will be omitted herein.

S303: The magnetic write data in the received ticket issuing instruction is written into the magnetic area of the ticket paper, and the magnetic write data includes the information of the valid ticket number for issuing the ticket for this time. To guarantee the accuracy of the magnetic write operation, a magnetic read operation may be added, and the read magnetic data is compared with the written magnetic data to confirm the validity of the magnetic write operation. This magnetic read process may be added or not according to actual demands and the description will be omitted herein.

S304: The ticket paper is conveyed to the printing head to get ready for printing. During this process, a positioning operation may be required, which is assisted by sensors, the description of which will be omitted herein.

S305: The ticket paper is printed, wherein the printing data in the received ticket issuing instruction is printed on the ticket paper wherein the printing data includes the information of the valid ticket number for issuing the ticket for this time.

S306: The ticket paper is sent out from the valid ticket outlet and taken away by a buyer or staffs.

Thus, the ticket to be issued this time has been processed, and in order to provide a valid ticket number for issuing the next ticket paper, it is also necessary to recognize the ticket number of the next ticket paper to be issued.

It should be noted that, for issuing non-magnetic ticket paper, the magnetic writing or magnetic reading step is not included.

The sub-flow 2 comprises the following detailed steps:

S307: The next ticket paper is conveyed to the scanning position for image acquisition to get ready for the image acquisition.

S308: The image of the next ticket paper is scanned to generate an acquired image in order to get ready for the OCR of the acquired image.

S309: It is determined whether the OCR is performed in the ticket issuing device or in the host computer. If the OCR is performed in the ticket issuing device, the processing is continued in S310. If the OCR is not performed in the ticket issuing device, the acquired image is sent to the host computer by S313, and then the host computer performs operations, such as the OCR and the validity determination of the recognized ticket number.

S310: The OCR of image is performed in the ticket issuing device, and the ticket number of the ticket paper is recognized from the scanned image and saved.

S311: The validity of the ticket number is processed. The ticket number recognized through the OCR is compared with the standard ticket number pre-saved in the ticket issuing device in advance to determine the validity of the ticket number. The specific process of processing the validity of the ticket number is learned by referring to the detailed description in FIG. 7. After the recognized ticket number is determined valid, the result of the determination is sent to the host computer, and the host computer stores the valid ticket number as the ticket number for issuing the next ticket paper.

S312: The result of processing the validity of the ticket number is sent to the host computer to get ready for issuing the ticket.

S314: The ticket paper is conveyed to the cutter to get ready for operation of the ticket issuing device.

It should be noted that, the sub-flow 1 and the sub-flow 2 also may be performed in series, that is, the sub-flow 1 is performed first and then the sub-flow 2 is performed. In this way, after the current ticket is issued, the ticket number of the next ticket paper is recognized to get ready for issuing the next ticket, which avoids the problem that the ticket issuing period is prolonged as it is necessary to wait for the recognition of the ticket number when the sub-flow 2 is performed first and then the sub-flow 1 is performed, thus the ticket issuing speed is improved.

The processing process of determining the validity of the recognized ticket number will be described in detail below, and as shown in FIG. 6, the specific steps are as follows:

S501: It is determined whether the length of the recognized ticket number is equal to the standard length. If the length of the recognized ticket number is not equal to the standard length, S508 is performed to process of the abnormal ticket number by manual assistant; if the length of the recognized ticket number is equal to the standard length, the next determination is performed.

S502: A policy for determining the validity of the ticket number is selected, and the policy for determining a valid ticket number may be a sequence policy and also may be an interval policy. If the interval policy is selected, it is continued by S503; if the sequence policy is selected, the further processing is performed by S506.

S503: It is determined whether the recognized ticket number is within the valid ticket number range, and, if the recognized ticket number is not within the valid ticket number range, S508 is performed to have manually assistant processing of the abnormal ticket number. The abnormality of the ticket number may be cased for the reason that the printing of the ticket paper may have some problems or that the ticket paper may be damaged or stuck with dust, and the like. If the recognized ticket number is within the valid ticket number range, the next determination is performed.

S504: It is determined whether the recognized ticket number has been used for issuing a ticket. If the ticket with the recognized ticket number has been issued, it is indicated that either the recognized ticket number is not correct or there is ticket paper with repeated ticket number. In any case, manual verification and confirmation is required, therefore S508 is performed to have manually assistant processing of the abnormal ticket number. If the recognized ticket number has not been used for issuing a ticket, it is indicated that the recognized ticket number is a confirmed recognized ticket number, and the confirmed ticket number is saved by S505 to get ready for ticket production. Simultaneously, it should be recorded that the ticket paper with the ticket number has been recognized, and the ticket number used for issuing a ticket needs to be recorded after the ticket issuing operation is completed.

S506: When the sequence policy is selected to determine the validity of the ticket number, it is determined whether the current recognized ticket number is equal to the previous recognized ticket number plus 1. If so, it is indicated that the recognized ticket number is accurate; if not, it is indicated that the recognized ticket number is in doubt, and manual confirmation is required. For recognizing the ticket number in sequence, determination also may be performed according to the descending of the ticket numbers, which needs cooperation with the ticket number coding policy of the ticket paper, as long as their coding policies are consistent.

S507: The valid ticket number confirmed at this time is saved to get ready for ticket production, and also get ready to determine the validity of the recognized ticket number of the next ticket paper.

S508: Manually assistant processing is performed for the abnormal ticket number, which is assistant processing performed for the recognized ticket number which cannot be automatically confirmed which needs manual assistance for further processing.

If the recognized ticket number can be confirmed, the manual assistance is not required, and the confirmation process of the validity of the ticket number ends herein. If the validity cannot be confirmed, manually assistant processing is still required. The specific processing process is learned by referring to the process description in FIG. 7.

S601: It is determined whether another automatic recognition of the ticket number is required. If another automatic recognition of the ticket number is required, a ticket number check instruction is sent to the ticket issuing device by S603, and the ticket issuing device performs operations again, such as image acquisition of the ticket paper and the OCR of the ticket number and the like, which may avoid recognition error of the ticket number resulted from causes that the ticket is deformed or stuck with dust. If another automatic recognition of the ticket number is not required, the processing is continued.

S602: It is determined whether the manual input of the ticket number is required. If the ticket paper to be recognized has problems indeed, such as unclear printing, incompleteness and deformed number, but the number still may be recognized manually, then the ticket paper to be recognized may be still used and there is no need to invalid it, and S606 is performed for corresponding processing. If the ticket paper to be recognized cannot be used due to incompleteness, damage or stain, corresponding voiding processing is performed.

S604: For ticket paper which cannot be used, a ticket paper voiding instruction is sent to the ticket issuing device. The ticket issuing device performs corresponding processing after receiving the instruction and then sends the voided ticket out from the abnormal ticket outlet. This processing process will not be described again.

S605: The host computer alarms, and records various related information of the ticket number recognition error, such as the sequential number of the ticket issuing device and the sequential number of the ticket paper, to provide a foundation for finding the cause of the ticket number recognition error.

S606: If the ticket paper still can be usable, the ticket number is input manually, and the ticket number manually input is recorded in S607 to get ready to produce the next ticket paper.

As the accuracy of the automatic recognition of the ticket number is very high, in normal conditions, manually assistant processing is hardly needed. The adding of the operation of manually assistant processing is to provide auxiliary measures in the case that the printing of the ticket paper is abnormal or the ticket issuing device has some problems, for example, in the case that the image acquisition unit is aged.

FIG. 9 shows by means of image the OCR of the ticket number of the ticket paper and the validity determination of the recognized ticket number, so as to learn the working process thereof more clearly and intuitively. Each step in FIG. 9 will be described below.

The ticket number of the ticket paper is printed on the top right of the ticket paper 110. The ticket number is 3872438578375932A08, where the digit “9” is not clear which may be caused by the printing unclear or stained and the like. After the image is acquired by the image acquisition device and the OCR is performed on the acquired image, the recognized ticket number is shown as 111, the unclear digit “9” is recognized as figure “8”, shown as the underlined digit “8” in 111, and the recognition of other characters is correct.

Then, the validity of the recognized ticket number is determined. Different determination policies may be selected for determining the validity of the ticket number. When continuous ticket paper is used, a policy for continuously adding 1 to or continuously subtracting 1 from the ticket number may be used. When non-continuous ticket paper is used, a number interval policy may be used, that is, the number may be regarded as a valid ticket number as long as the recognized number is within a number interval. In 112 in FIG. 9, the number interval policy is used, and the ticket number interval is:

3872438578375932A00-3872438578375933A99

The recognized number is not within the number interval, so that it may be regarded that the recognized ticket number is not correct. As shown in 113, the correct number should be 3872438578375932A08, however, this number needs manual confirmation as shown in 114. From the above processing flow, it may be known that, when OCR is performed, it is necessary to notify the host computer as long as the recognized character is in doubt, in order to perform manual confirmation operation on the result of the determination of the ticket number. As the printing of the ticket number of the ticket paper is very clear in normal conditions, that the number is indefinite during the OCR is almost impossible.

When the recognition of the ticket number is abnormal, it is necessary to perform independent recognition and validity determination on the ticket number, and the processing flow thereof is as shown in FIG. 8 and specifically described as follows:

S401: Conveying the ticket paper to the scanning position for image acquisition to get ready for the image acquisition.

S402: Scanning the ticket paper to generate an acquired image in order to get ready for the OCR of the acquired image.

S403: It is determined whether the OCR is performed in the ticket issuing device or in the host computer. If the OCR is performed in the ticket issuing device, processing is continued by S404. If the OCR is not performed in the ticket issuing device, that is, the OCR is performed in the host computer, the acquired image is sent to the host computer by S407, and then the host computer performs the OCR and the validity determination of the recognized ticket number.

S404: The OCR of image is performed in the ticket issuing device, and the ticket number of the ticket paper is recognized from the scanned image and saved.

S405: The validity of the ticket number is processed. The ticket number recognized through the OCR is compared with the standard ticket number saved in the ticket issuing device in advance to determine the validity of the ticket number, and the specific process of processing the validity of the ticket number refers to the detailed description in FIG. 6.

S406: The result of determination, i.e., whether the ticket number is valid and the recognized ticket number, is sent to the host computer, to get ready for the ticket production of the current ticket paper on the host computer.

S408: The ticket paper is conveyed to the cutter to get ready for the ticket issuing operations of the ticket issuing device.

During the ticket issuing process, the control method of automatically scanning the ticket paper, automatically recognizing the ticket number from the scanned image, and printing and writing the ticket issuing information including the recognized ticket number not only omits the trouble of the manual input of the ticket number, but also greatly improves the accuracy of the input of the ticket number and improves the working efficiency of the ticket production. The ticket issuing method and the ticket issuing device can be applied to ticket paper under various numbering rules according to different policies for recognizing ticket numbers, and the disadvantage that the ticket numbers have to be consecutive numbers during the existing ticket issuing process is overcome.

Above contents only describe the preferred embodiments of the present invention and are not intended to limit the present invention; for one skilled in the art, the present invention may have various modifications and changes. Any modifications, equivalent replacements and improvements made within the spirit and principle of the present invention should be included within the protection scope of the present invention.

1. A ticket issuing method, comprising:
Step a: acquiring the image of a ticket paper for issuing a ticket, recognizing a ticket number from the image acquired and determining the validity of the ticket number recognized, to obtain a valid ticket number; and
Step b: printing on the corresponding ticket paper the ticket issuing information containing the ticket number, when receiving a ticket issuing instruction.

2. The ticket issuing method according to claim 1, wherein after Step a is completed, the valid ticket number recognized in Step a is stored, and correspondingly, in Step b, the stored valid ticket number is printed on the corresponding ticket paper as one part of the ticket issuing information.

3. The ticket issuing method according to claim 2, wherein,
Step b is executed previously to or simultaneously with Step a, the valid ticket number obtained in Step a is one part of the ticket issuing information used for the next ticket issuing instruction, and the ticket issuing information used in Step b contains the valid ticket number which has been already stored and is used for the current ticket issuing instruction.

4. The ticket issuing method according to claim 2, wherein,
in the case of continuous ticket paper for ticket production, after Step a is completed, the continuous ticket paper is conveyed to a paper cutting position, and an individual ticket paper is cut off from the continuous ticket paper.

5. The ticket issuing method according to claim 1, wherein in Step a, the validity of a ticket number is recognized by an interval policy or a sequence policy of ticket numbers.

6. The ticket issuing method according to claim 1, wherein, in Step b, when the ticket paper is a magnetic ticket paper, the ticket issuing information is also written into the magnetic area of the magnetic ticket paper.

7. A ticket issuing device, comprising:
an image acquisition unit, configured to acquire the image of ticket paper for issuing a ticket;
a printing unit, configured to print the ticket issuing information on the ticket paper; and
a controller, configured to send the image of the ticket paper acquired by the image acquisition unit or the ticket number recognized from the image of the ticket paper to a host computer and control the printing unit to print on the ticket paper according to the ticket issuing instruction and the ticket issuing information received.

8. The ticket issuing device according to claim 7, further comprising:
a memory, configured to store the ticket issuing information sent by the host computer according to the ticket number,
wherein the controller receives the ticket issuing information from the memory.

9. The ticket issuing device according to claim 7, further comprising:
a magnetic write unit, configured to write the ticket issuing information into a magnetic area of the ticket paper, wherein the controller further controls the magnetic write operation of the magnetic write unit according to the ticket issuing instruction.

10. The ticket issuing device according to claim 9, wherein the image acquisition unit, the magnetic write unit and the printing unit are arranged on a ticket paper processing passage of the ticket issuing device in sequence, wherein a ticket cutting mechanism is also arranged on the ticket paper processing passage between the image acquisition unit and the magnetic write unit, for cutting off an individual ticket paper from the continuous ticket paper.

11. The ticket issuing method according to claim 3, wherein,
in the case of continuous ticket paper for ticket production, after Step a is completed, the continuous ticket paper is conveyed to a paper cutting position, and an individual ticket paper is cut off from the continuous ticket paper.

12. The ticket issuing device according to claim 8, further comprising:
a magnetic write unit, configured to write the ticket issuing information into a magnetic area of the ticket paper, wherein the controller further controls the magnetic write operation of the magnetic write unit according to the ticket issuing instruction.
